(19) United States
(12) Patent Application Publication
(10) Pub. No.: US 2025/0323300 A1
(43) Pub. Date: Oct. 16, 2025

(54) Fuel Exhaust Dilution for Fuel Cell System

(71) Applicant: Infintium Fuel Cell Systems, Inc., Greenville, SC (US)

(72) Inventor: Ryan Victor Feltman, Anderson, SC (US)

(21) Appl. No.: 19/096,324

(22) Filed: Mar. 31, 2025

Related U.S. Application Data
(60) Provisional application No. 63/634,091, filed on Apr. 15, 2024.

(51) Int. Cl. H01M 8/0662

(52) U.S. Cl. CPC H01M 8/0662

(57) ABSTRACT

A fuel exhaust dilution structure may include a first chamber and a second chamber. The first chamber may include a first inlet through which a fuel exhaust stream generated by a fuel cell stack enters the fuel exhaust dilution structure, a second inlet for receiving ambient air, and a tunnel within the first chamber and connected to the first inlet. The tunnel receives the fuel exhaust stream from the first inlet, and is positioned and shaped to draw the ambient air into the first chamber through the second inlet. The second chamber may be connected to the first chamber. The second chamber is configured to receive and mix the fuel exhaust gas and the ambient air to generate a mixed gas. The second chamber includes an outlet through which the mixed gas exits the fuel exhaust dilution structure.

### CROSS-REFERENCE TO RELATED APPLICATIONS

This patent application claims priority to U.S. Provisional Application No. 63/634,091, filed on Apr. 15, 2024 and entitled “Fuel Exhaust Dilution for Fuel Cell System,” which is incorporated herein by reference as if reproduced in its entirety.

### TECHNICAL FIELD

The present disclosure relates generally to the field of fuel cell systems, and in particular embodiments, to techniques and mechanisms for fuel exhaust dilution in a fuel cell system.

### BACKGROUND

Fuel cell systems are power supply systems designed to generate electricity through a chemical reaction between a fuel and an oxidizing agent. As an example, a fuel cell system may use hydrogen as the fuel and oxygen from the air as the oxidizer, producing only water and heat generated as byproducts. Compared to traditional combustion-based power generation technologies, fuel cell systems generate electricity with lower emissions. Compared to batteries or combustion engines, fuel cells are more efficient, and eliminate the need to change, charge or manage batteries, which saves both labor and space. Other advantages of fuel cell systems include higher energy density, extended lifespan, rapid refueling/recharging capabilities, environmentally friendly operation, enhanced efficiency, scalability, and more. Fuel cell systems offer a clean, efficient, and versatile solution for a wide range of power generation applications, e.g., providing backup power, providing power supply in remote locations, such as spacecraft, remote weather stations, large parks, communications centers, rural locations, and so on, and powering fuel cell vehicles, such as forklifts, automobiles, buses, trains, boats, motorcycles, and so on.

It is thus desirable to develop techniques and mechanisms to improve performance of fuel cell systems in various aspects, and to facilitate utilization of fuel cell systems.

### SUMMARY

Technical advantages are generally achieved, by embodiments of this disclosure which describe mechanisms and structures for fuel exhaust dilution in a fuel cell system.

In accordance with one aspect of the present disclosure, a fuel exhaust dilution structure is provided that includes: a first chamber and a second chamber. The first chamber may include a first inlet through which a fuel exhaust stream generated by a fuel cell stack enters the fuel exhaust dilution structure, a second inlet for receiving ambient air, and a tunnel within the first chamber and connected to the first inlet. The tunnel receives the fuel exhaust stream from the first inlet, and is positioned and shaped to draw the ambient air into the first chamber through the second inlet. The second chamber may be connected to the first chamber. The second chamber is configured to receive and mix the fuel exhaust gas and the ambient air to generate a mixed gas. The second chamber includes an outlet through which the mixed gas exits the fuel exhaust dilution structure. an outlet through which the mixed gas exits the fuel exhaust dilution structure.

In accordance with another aspect of the present disclosure, a method for operating a fuel exhaust dilution structure for a fuel cell system is provided that includes: receiving a fuel exhaust stream generated by a fuel cell stack through a first inlet of a first chamber within a fuel exhaust dilution structure, directing the fuel exhaust stream through a tunnel within the first chamber, wherein the tunnel is positioned and shaped to draw ambient air into the first chamber through a second inlet of the first chamber, directing the fuel exhaust stream and the ambient air into a second chamber within a fuel exhaust dilution structure, wherein the second chamber is connected to the first chamber and is configured to mix the fuel exhaust stream and the ambient air to generate a mixed gas, and expelling the mixed gas through an outlet of the second chamber, wherein the mixed gas has a reduced fuel concentration compared to the fuel exhaust stream received at the first inlet.

Features described in the context of one embodiment may be used in combination with other embodiments. For example, each of the optional features described above in the context of the apparatus may be used in combination with the system. Each of the optional features described above in the context of the method may be used in combination with the system. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an example fuel cell power supply system in a perspective view in accordance with various embodiments of the present disclosure;

FIG. 2 is a schematic block diagram of the example fuel cell power supply system in FIG. 1 in accordance with various embodiments of the present disclosure;

FIG. 3 is a schematic diagram of an example fuel cell in accordance with various embodiments of the present disclosure;

FIG. 4 is a schematic cross-sectional view of an example fuel exhaust dilution structure for diluting fuel exhaust generated by a fuel cell system in accordance with various embodiments of the present disclosure; and

FIG. 5 illustrates a flow chart of an example method for fuel exhaust dilution in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

In addition, terms “first”, “second”, and so on, are only used to distinguish one feature (e.g., one entity or operation) from another feature (e.g., another entity or operation), and should not be interpreted as indicating or implying a relative importance, an order, or a quantity of indicated features. A feature limited with “first” or “second” may explicitly indicate or implicitly include one or more of the features.

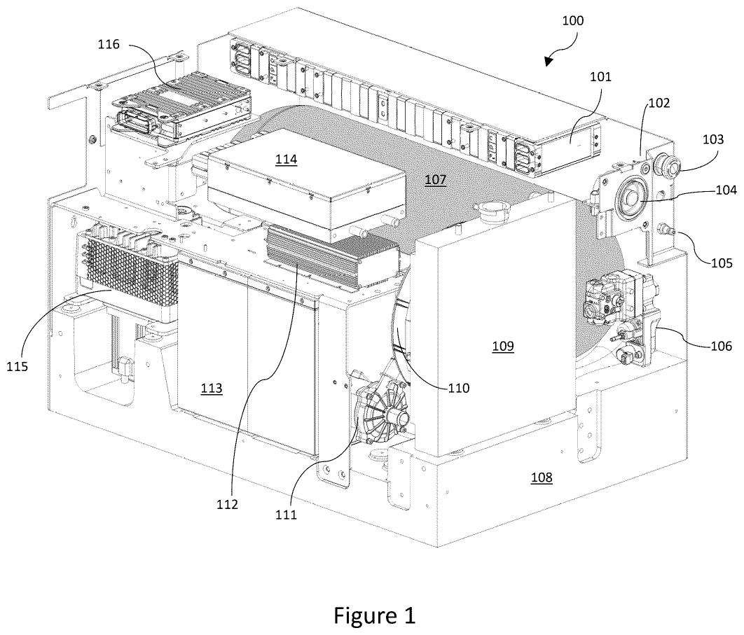

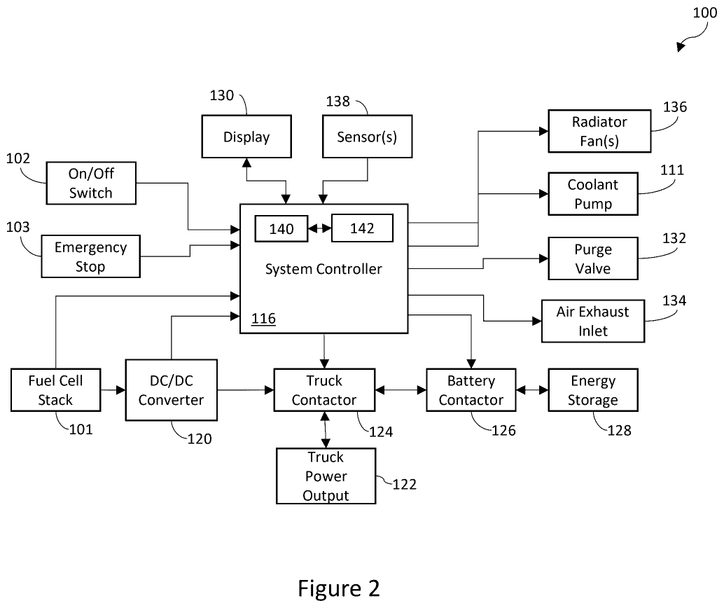

The following description is provided with reference to FIG. 1 and FIG. 2. FIG. 1 is a diagram of an example fuel cell power supply system in a perspective view according to embodiments of the present disclosure. FIG. 2 is a schematic block diagram of the example fuel cell power supply system in FIG. 1, which shows an example implementation of the fuel cell power supply system. In this example, the fuel cell power supply system uses hydrogen as the fuel. However, hydrogen is merely used as an example for illustration purpose. Any other fuel applicable for fuel cell power systems may also be used. The terms of “fuel cell power supply system”, “fuel cell power system”, “fuel cell system” and “system” are used interchangeably in the present disclosure.

The fuel cell system 100 as shown in FIG. 1 may include an fuel cell stack 101, an on/off switch 102, an emergency stop switch 103, a fill port 104, a drain port 105, a pressure regulator 106, a fuel storage tank 107, a system base frame 108, radiator assembly 109, a radiator fan 110, a coolant pump 111, a low power dc/dc converter 112, a battery 113, a high power dc/dc converter 114, an air compressor 115, and a system controller 116. The fuel cell system 100 may further include a truck power output 122, a truck contactor 124, a battery contactor 126, an energy storage device 128, a display 130, a purge valve 132, and an air exhaust inlet 134, which are not shown in FIG. 1.

Components of the fuel cell system 100 in this example are mainly arranged on or above the system base frame 108 in a system housing (not shown). The fuel cell stack 101 may be arranged close to a rear plate of the fuel cell system 100. As an example, the fuel cell stack 101 may be mounted on the rear plate. The rear plate may be part of the system housing. The fuel cell stack 101 may include one or more fuel cells, which may be combined in series into a fuel cell stack (stacked on top of each other) as typically used.

A fuel cell is an electrochemical cell that converts the chemical energy of a fuel (e.g., hydrogen) and an oxidizing agent (e.g., oxygen) into electricity through an electrochemical reaction. As is well known, a fuel cell typically includes an anode, cathode, and an electrolyte membrane. As an example, in a hydrogen fuel cell, hydrogen is passed through the anode, and oxygen is passed through the cathode. At the anode, a catalyst splits the hydrogen molecules into electrons and protons. The protons pass through the porous electrolyte membrane, while the electrons pass through an external circuit, generating an electric current. At the cathode, the protons, electrons, and oxygen combine to produce water and heat. A typical fuel cell stack may include hundreds of fuel cells. The amount of power produced by a fuel cell may depend upon various factors, such as the fuel cell type, the fuel cell size, the temperature at which it operates, and the pressure of the gases supplied to the fuel cells, and so on.

The on/off switch 102 is used to turn on or off the fuel cell system 100. The emergency stop switch 103 is configured to stop operation of the fuel cell system 100 immediately in case of emergency, e.g., by cutting off the supply of the fuel.

The fuel (i.e., hydrogen) of the fuel cell system 100 is stored in the fuel tank 107. The fuel tank 107 may be arranged below the fuel cell stack 101. The fuel may be filled into the fuel tank 107 through the fill port 104. Fuel exhaust may be discharged through the drain port 105. The fuel exhaust may primarily include water and non-reactive components, such as traces of unreacted fuel, and possible impurities entering the fuel. The drain port 105 may be closed by the purge valve 132 (not shown in FIG. 1), which will temporarily be opened during purge of the fuel cell stack 101 for discharging the fuel exhaust. Fuel stored in the fuel tank 107 is maintained at a certain pressure level, which may be adjusted through the pressure regulator 106.

The radiator assembly 109 is configured to manage the temperature of the fuel cell system 100 by dissipating excess heat generated during the electrochemical reactions that occur within the fuel cell stack 101. The radiator assembly 109 may include cooling components such as the radiator fan 110 for dissipating heat and the coolant pump 111 for pumping coolant. Hot/warm exhaust air from the fuel cell stack 101 may enter the air exhaust inlet 134 at the radiator assembly 109, be cooled down through the radiator assembly 109, and be re-circulated back to the fuel cell stack 101.

The amount of air available for the electrochemical reaction at the fuel cell stack 101 affects the performance of the fuel cell system 100. Fuel cell performance improves as the pressure of the reactant gases increases. The air compressor 115 is used to push air into the fuel cell stack 101 such that the air is provided to the fuel cell stack 101 at a desired flow rate. As an example, the air compressor 115 may raise the pressure of the incoming air of the fuel cell stack 101 to about 2˜4 times the ambient atmospheric pressure of the fuel cell stack 101.

The fuel cell stack 101 is coupled to a DC/DC converter 120 including the low power DC/DC converter 112 and the high power DC/DC converter 114. Fuel cells produce electricity in the form of direct current (DC). The electric power generated by the fuel cell stack 101 may be converted to different levels of DC power to match various load requirements by the DC/DC converter 120, e.g., to low DC power and high DC power by the low power DC/DC converter 112 and the high power DC/DC converter 114, respectively. The output of the DC/DC converter 120 may be a current or voltage. As an example, the DC/DC converter 120 may be configured to convert a DC voltage output by the fuel cell stack 101 to desired voltage(s). The fuel cell system 100 may include various numbers of DC/DC converters depending on the designs and applications of the fuel cell system 100.

The DC/DC converter 120 may include a communication module, an input voltage measurement module, an input current measurement module, an output voltage measurement module, and/or an output current measurement module. In some embodiments, the DC/DC converter 120 may control, according to the communication data of the communication module, specific numerical values of the output current and voltage, and output, through the communication module, data such as input voltages, input currents, output voltages, output currents, output currents, etc. The state data of the DC/DC converter 120 may include DC/DC input currents, and/or DC/DC input voltages.

The DC/DC converter 120 may be connected to the truck power output 122 through the truck contactor 124. The truck contactor 124 may be a normal open type high-current contactor. The fuel cell system 100 supplies the electric energy generated by the fuel cell stack 101 to external devices/apparatus (referred to as external power receivers thereafter) through the truck power output 122.

The DC/DC converter 120 may also be connected to the energy storage device 128 through the truck contactor 124 and the battery contactor 126. The electric energy generated by the fuel cell stack 101 may be stored in the energy storage device 128, e.g., the battery 113. The energy stored in the energy storage device 128 may also be supplied to the external power receivers through the battery contactor 126, the truck contactor 124 and the truck power output 122.

The system controller 116 is configured to manage and control operation of the fuel cell system 100. The system controller 116 may include one or more processors 140, such as microprocessors or microcontrollers, which are appropriately configured to carry out fuel cell system operations. The system controller 116 may further include a computer-readable storage device 142 storing computer-readable instructions, which may be executed by the one or more processors 140 of the system controller 116 for carrying out the fuel cell system operations. The computer-readable storage device 142 may include any non-transitory mechanism for storing information in a form readable by a machine (e.g., a computer, a processor). For example, a computer-readable storage device may include read-only memory (ROM), random-access memory (RAM), magnetic disk storage media, optical storage media, flash-memory devices, solid state storage media, and other storage devices and media.

The system controller 116 may be a controller with an integrated design, which may be a scattered fuel cell controller, a whole vehicle controller, or a battery energy management system. The system controller 116 may include an energy management unit, a fuel cell control unit, an energy storage device monitoring unit, a fuel safety monitoring unit, a system failure monitoring unit and/or a startup control unit.

As shown in FIG. 2, the system controller 116 may be connected to various components of the fuel cell system 100, such as the on/off switch 102, the emergency stop 103, the fuel cell stack 101, the DC/DC converter 120, radiator fan(s) 136 such as the radiator fan 110, the coolant pump 111, the purge valve 132, the air exhaust inlet 134, the truck power output 124 through the truck contactor 124, and the energy storage 128 through the battery contactor 126.

As an example, when the on/off switch 102 is switched off, the system controller 116 may receive a signal indicating the switching off of the on/off switch 102, and control to stop operations of the fuel cell system 100, e.g., cutting off the fuel supply to the fuel cell stack 101, turning off the radiator fan(s) 136, and so on. As another example, the system controller 116 may control supplying power to external power receiver(s) and storing energy in the energy storage device 128. As yet another example, the system controller 116 may control to close and open the purge value 132 to discharge fuel exhaust.

The system controller 116 may be connected to the display 130, through which users/operators may interact with the fuel cell system 100. For example, a user may enter instructions through the display 130 and/or set parameter(s) for operations of the fuel cell system 100. A user may monitor operation status or parameters/information displayed on the display 130. The display 130 may be integrated with the system controller 116.

The system controller 116 may be connected to one or more sensors 138. The sensor(s) 138 may include various devices for detecting/sensing/measuring parameters of the fuel cell system 100, such as thermometer(s), timer(s), gas density sensor(s)/meter(s), moisture meter(s), and so on. The sensor(s) 138 may be positioned at various locations depending on their purposes.

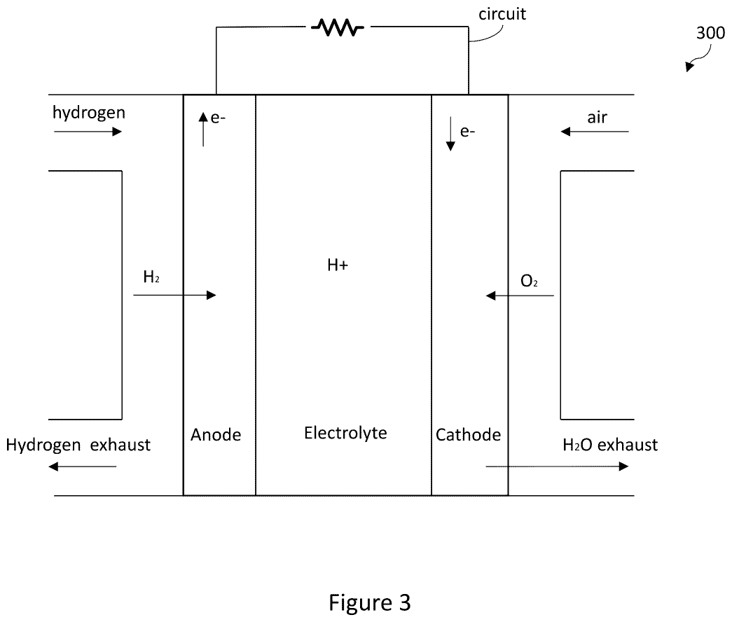

FIG. 3 is a schematic diagram of an example fuel cell 300. The fuel cell 300 includes an anode, an electrolyte and a cathode arranged in sequence as shown. At the anode, a catalyst facilitates the ionization of the fuel, e.g., hydrogen, turning the fuel into a positively charged ion and a negatively charged electron. Taking hydrogen as an example, the hydrogen molecules are split into protons (H+) and electrons (e−). The electrolyte is specifically designed to allow only positively charged ions (protons) to pass through. The electrons, which cannot pass through the electrolyte, travel through an external circuit creating an electric current that can be used to power electrical devices. The protons travel through the electrolyte to the cathode. Oxygen (O₂) from the air is supplied to the cathode side of the fuel cell. At the cathode, oxygen molecules combine with protons that have traveled through the electrolyte and electrons from the circuit to form water (H₂O) through electrochemical reduction. The hydrogen exhaust (e.g., unreacted hydrogen) and the water produced are typically exhausted from the fuel cell.

Operation of a fuel cell system produces fuel exhaust (or exhaust stream) that needs to be released into the environment. Taking a hydrogen fuel cell system as an example, the fuel exhaust from a hydrogen fuel cell primarily includes water vapor (H₂O) (i.e., water exhaust) and traces of unreacted hydrogen (H₂) (i.e., hydrogen exhaust), as discussed above with respect to FIG. 3. Unreacted hydrogen poses safety risks due to its flammability and potential for combustion in the presence of oxygen.

A fuel exhaust dilution system may be designed to safely manage the release of the fuel exhaust, where a dilution process may be performed to dilute the exhaust concentration. Generally, in the dilution process, the discharged fuel exhaust is mixed with other gases, typically air, to reduce the its concentration before it is released into the environment. In some examples, a dilution chamber or a mixing unit may be provided in the fuel exhaust dilution system. The dilution chamber allows the fuel exhaust to mix with ambient air or other gases, effectively diluting the concentration of the fuel gas (e.g., hydrogen). A control mechanism may be employed to regulate the flow of gases within the fuel exhaust dilution system, ensuring proper mixing and dilution of the fuel exhaust. Mechanisms may also be provided to monitor fuel exhaust concentration levels, to ensure compliance with safety standards and environmental regulations which impose limits on the concentration of fuel exhaust emissions from fuel cell systems to protect public safety and air quality. Fuel exhaust dilution is an important aspect of fuel cell system design and operation, contributing to both safety and environmental protection.

Existing hydrogen dilution technology incorporates blending of the air (cathode) fluid stream to actively dilute and/or mix with the hydrogen exiting a fuel cell system. This requires the air (cathode) system to be coupled to the purge/fuel (anode) system to mix completely by forcing the cathode system to induce flow in an outlet air stream of the fuel cell system. It is desirable to develop an exhaust dilution mechanism that decouples the fuel (anode) and air (cathode) systems to allow both to run independently to meet their respective system performance specifications, while maintaining acceptable fuel exhaust concentration levels in the exhaust (or purge) stream.

Embodiments of the present disclosure incorporate a fuel exhaust dilution structure coupled to a fuel cell system at a location where the fuel exhaust stream (e.g., the hydrogen exhaust stream) is purged out of the fuel cell system. In some other embodiments, the fuel exhaust dilution structure may be integrated into the fuel cell system at a location where the fuel exhaust stream (e.g., the hydrogen exhaust stream) is purged. The fuel exhaust dilution structure mixes the fuel exhaust with surrounding ambient air, and forces mixing of both gases that result in a natural dilution of fuel exhaust gas below acceptable limits without the need of introduction of any supplemental electromechanical devices.

The disclosed fuel exhaust dilution structure and method may be used to dilute fuel exhaust gases from various fuel sources, reducing their concentration to safe levels. For example, when applied to hydrogen exhaust, the structure can lower its concentration to 25% of the hydrogen gas Lower Flammability Limit (LFL), where the LFL for hydrogen gas is 4%. This means the hydrogen concentration in the mixed gas is lowered to 1% or less upon exiting from the fuel exhaust dilution structure, ensuring it remains well below flammable levels. The embodiments may be utilized to reduce the concentration of flammable gases or vapors to below 1%, under various operating conditions and normal release scenarios, thereby minimizing ignition risks and enhancing system safety.

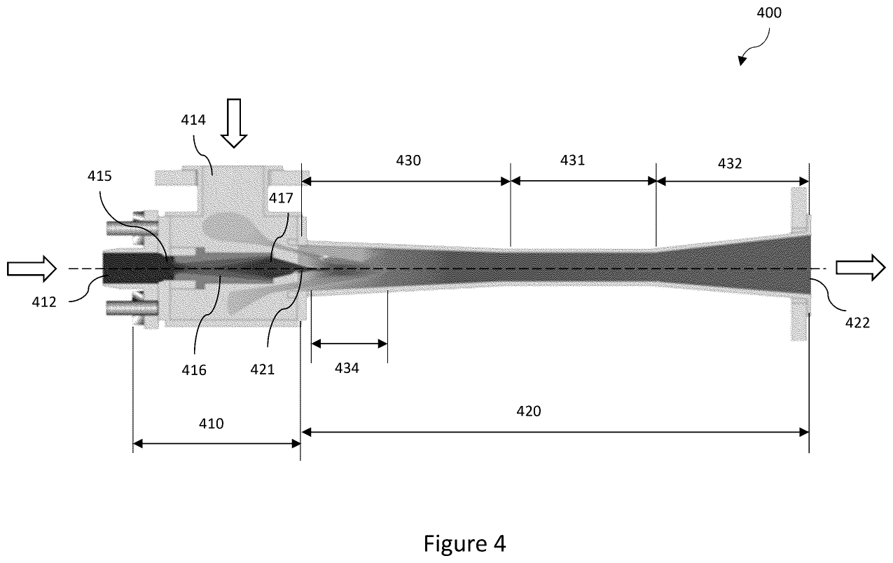

FIG. 4 is a schematic cross-sectional view of an example fuel exhaust dilution structure 400 that is configured to dilute fuel exhaust generated by a fuel cell system according embodiments of the present disclosure. The fuel exhaust dilution structure 400 allows fuel exhaust to flow in, flow through the fuel exhaust dilution structure 400, and be diluted with air before the fuel exhaust exits the fuel exhaust dilution structure 400.

The fuel exhaust dilution structure 400 comprises a first chamber 410 and a second chamber 420. In some embodiments, the longitudinal axis of the first chamber 410 aligns with the longitudinal axis of the second chamber 420, ensuring a streamlined flow path for the exhaust mixture. In some embodiments, the first chamber 410 and a second chamber 420 may be structurally integrated into a single unit. The length of the second chamber 420 is greater than that of the first chamber 410. In some embodiments, the length of the second chamber 420 may be equal to or greater than three times the length of the first chamber 410. The first chamber 410 comprises a fuel exhaust inlet 412, an ambient air inlet 414, and a venturi tunnel 416 within the first chamber 410. The fuel exhaust inlet 412 may be positioned on the side of a first end of the first chamber 410 and is configured to receive fuel (e.g., hydrogen) exhaust from the fuel cell system, directing it into the fuel exhaust dilution structure 400. In some embodiments, the fuel exhaust inlet 412 is aligned with the first chamber 410's longitudinal axis. In some embodiments, the concentration of hydrogen or other fuel gases in the fuel exhaust entering the fuel exhaust inlet 412 may be equal to or less than 99.95%, depending on the specific fuel type and operating conditions. As an example, the fuel exhaust inlet 412 may be connected to a fuel cell exhaust outlet of a fuel cell stack 101 (not shown). The fuel exhaust exiting from the fuel cell exhaust outlet enters the fuel exhaust dilution structure 400 through the fuel exhaust inlet 412. The venturi tunnel 416 is connected to the fuel exhaust inlet 412. In some embodiments, the longitudinal axis of the venturi tunnel 416 is aligned with the longitudinal axis of the fuel exhaust inlet 412, and the longitudinal axis of the second chamber 420, directing the incoming fuel exhaust efficiently through the first chamber 410 and the second chamber 420. As the fuel exhaust enters through the fuel exhaust inlet 412, it is contained within and flows through the venturi tunnel 416.

The ambient air inlet 414 may be positioned near the first end of the first chamber 410, but separate from the fuel exhaust inlet 412. The ambient air inlet 414 is configured to allow ambient air to enter the fuel exhaust dilution structure 400, facilitating the dilution of fuel exhaust within the first chamber 410. In some embodiments, the ambient air inlet 414 may be located in an upper portion of the first chamber 410 and oriented perpendicular to the fuel exhaust inlet 412 along the first chamber 410's longitudinal axis. This configuration allows ambient air to enter the fuel exhaust dilution structure 400 at a 90-degree angle relative to the fuel exhaust flow. This airflow aids in diluting and mixing with the fuel exhaust to reduce its concentration. The venturi tunnel 416 may be positioned and shaped such that, as the fuel exhaust stream flows through it, ambient air is drawn into the first chamber 410 via the ambient air inlet 414.

The venturi tunnel 416 comprises a tunnel inlet 415 and a tunnel outlet 417. In some embodiments, the tunnel outlet 417 may have a wider opening than the tunnel inlet 415. The tunnel inlet 415 is connected to the fuel exhaust inlet 412. At the tunnel inlet 415, fuel exhaust enters the venturi tunnel 416 at relatively low velocity and high pressure. The venturi tunnel 416 may comprise three sections: a converging section, a throat region, and an expanding section. The converging section of the venturi tunnel 416 is positioned after the tunnel inlet 415 and has an internal space gradually narrows in a cross-sectional view. The converging section directs the incoming fuel exhaust stream toward the throat region. This converging section accelerates the fuel exhaust flow while reducing pressure as it nears the narrowest part of the venturi tunnel 416.

The throat region is positioned between the converging section and the expanding section. The throat region is the narrowest part of the venturi tunnel 416. As the fuel exhaust stream passes through the throat region of the venturi tunnel 416, its velocity increases and pressure drops due to venturi effect. This drop in pressure is essential for inducing air from the ambient air inlet 414.

The expanding section has an internal space that gradually widens in a cross-sectional view. This expending section allows for the controlled dispersion of the high-speed fuel exhaust stream into a turbulent mixing zone 434 within the second chamber 420. The high-speed fuel exhaust stream creates a low-pressure zone near the tunnel outlet 417. This low-pressure zone creates a suction effect, and pulls in ambient air from the ambient air inlet 414 into the first chamber 410. This suction effect also assists in drawing fuel exhaust from the fuel exhaust inlet 412 into the first chamber 410, ensuring efficient gas mixing within the turbulent flow region 434 in the second chamber 420.

The second chamber 420 comprises a mixed gas inlet 421 and a diluted exhaust outlet 422. The mixed gas inlet 421 is positioned at a first end of the second chamber 420, while the diluted exhaust outlet 422 is located at a second end of the second chamber 420. In some embodiments, the mixed gas inlet 421 and the diluted exhaust outlet 422 may align along the same axis and position opposite each other. The fuel exhaust flowing out of the venturi tunnel 416 and the ambient air suctioned into the first chamber 410 enter the mixed gas inlet 421 of the second chamber 420. At or near the inlet 421, the ambient air and fuel exhaust mix, initiating turbulent flow within the turbulent flow region 434, as shown in FIG. 4. The turbulent interaction enhances the mixing process, effectively reducing the hydrogen concentration in the second chamber 420. As the gases flow through the second chamber 420, the mixture stabilizes, leading to a more controlled and uniformly diluted exhaust output. The mixed and diluted gases then exits the fuel exhaust dilution structure 400 through the diluted exhaust outlet 422.

In some embodiments, the second chamber 420 may comprise a decreasing section 430, a middle section 431, and a diffusion section 432. Upon entering the second chamber 420, the mixed gases pass through the decreasing section 430 where the cross-sectional area gradually decreases. This converging effect accelerates the gas flow and enhances turbulent mixing. The reduction in cross-sectional area also helps maintain a low-pressure region, further supporting the continued entrainment of ambient air and fuel exhaust into the mixing process. Following the decreasing section 430, the mixed gases pass through the middle section 431, which has a uniform circumference. The middle section 431 provides a transition zone, allowing the velocity and turbulence of the gas mixture to stabilize before further expansion. After the middle section 431, the mixed gases enter the diffusion section 432, where the cross-sectional area gradually increases. The diffusion section 432 slows down the mixed gas, allowing further diffusion and ensuring that the fuel exhaust concentration is sufficiently reduced before reaching the diluted exhaust outlet 422. The diffusion section 432 also serves to stabilize the flow and prevent excessive backpressure buildup, facilitating smooth exhaust dispersion through the diluted exhaust outlet 422. In some other embodiments, the middle section 431 may be omitted. In some embodiments, the diluted exhaust outlet 422 may have a wider opening than the mixed gas inlet 421. In some other embodiments, the diluted exhaust outlet 422 may have an equal width opening as the mixed gas inlet 421.

In some embodiments, instead of a single ambient air inlet 414, multiple inlets could be positioned at various locations to enhance air entrainment and improve the mixing efficiency of the fuel exhaust dilution structure 400.

In some embodiments, the ambient air inlet 414 may include a valve or adjustable opening to regulate the amount of air entering the system based on operational needs. The valve can be controlled by the system controller 116, allowing dynamic airflow adjustments. Additionally, sensors may be integrated to monitor hydrogen concentration, airflow rate, and exhaust conditions, enabling real-time optimization of the dilution process. Based on the monitored parameters, the system may dynamically adjust the amount of air entering the first chamber 410.

The fuel exhaust dilution structure 400 may be constructed from ceramic, composite materials, or heat-resistant alloys to ensure durability and reliable operation under extreme temperature and chemical conditions.

The fuel exhaust dilution structure 400 utilizes the venturi effect in the fuel exhaust stream. By introducing a converging section into the fuel exhaust stream, a low pressure, high velocity section is created that entrains the surrounding air into the low-pressure flow of the fuel exhaust stream. As the air is pulled into the low-pressure fluid flow of fuel exhaust, it experiences turbulent flow resulting in mixing of the two gases. This mixing diffuses the fuel exhaust gas, reduces the fuel exhaust concentration below the acceptable limits before the fuel exhausting out of the fuel exhaust dilution structure 400 through the diluted exhaust outlet 422.

Those of ordinary skill in the art would recognize that the fuel exhaust dilution structure 400 may have different shapes and dimensions depending on the applications, given that the venturi effect is provided through the fuel exhaust dilution structure 400. For example, the second chamber 420 may feature a uniform circumference, alternative cross-sectional geometries, or additional turbulence-inducing structures to optimize mixing efficiency. The embodiments may be applied for diluting other types of fuels as used in fuel cell systems without departing from principle and spirit of the present disclosure.

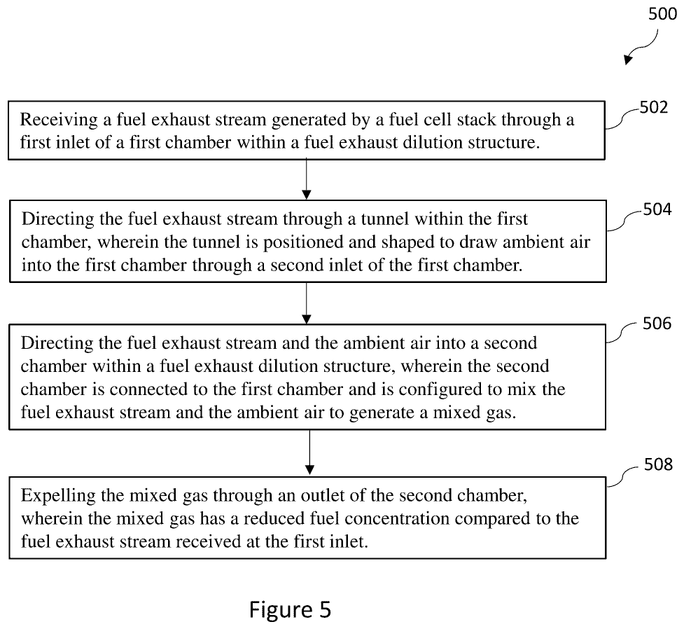

FIG. 5 is a flowchart of an example method 500 for fuel exhaust dilution for a fuel cell system in accordance with various embodiments of the present disclosure. The method 500 provides example operations, particularly in forklift applications, to dilute fuel exhaust generated by the fuel cell system, as described with respect to FIGS. 1-4.

At step 502, receiving a fuel exhaust stream generated by a fuel cell stack through a first inlet of a first chamber within a fuel exhaust dilution structure.

At step 504, directing the fuel exhaust stream through a tunnel within the first chamber, wherein the tunnel is positioned and shaped to draw ambient air into the first chamber through a second inlet of the first chamber.

At step 506, directing the fuel exhaust stream and the ambient air into a second chamber within a fuel exhaust dilution structure, wherein the second chamber is connected to the first chamber and is configured to mix the fuel exhaust stream and the ambient air to generate a mixed gas.

At step 508, expelling the mixed gas through an outlet of the second chamber, wherein the mixed gas has a reduced fuel concentration compared to the fuel exhaust stream received at the first inlet.

In some embodiments, the tunnel within the first chamber comprises a throat region configured to create a Venturi effect, with the throat region being a narrowest part of the tunnel in a cross-sectional view, generating a low-pressure zone downstream of the tunnel to draw the ambient air through the second inlet of the first chamber.

The method may further comprise passing the fuel exhaust stream through a converging section of the tunnel, wherein the converging section gradually narrows in a cross-sectional view; directing the fuel exhaust stream through the throat region, which is located between the converging section and an expanding section of the tunnel; and passing the fuel exhaust stream through the expanding section, wherein the expanding section gradually widens in a cross-sectional view.

In some embodiments, the second chamber comprises a decreasing section, a middle section, and a diffusion section. The method may further comprise passing the fuel exhaust stream and the ambient air through the decreasing section, which gradually narrows in a cross-sectional view, mixing the fuel exhaust stream and the ambient air and generating a turbulent flow in the decreasing section, passing the mixed gas through the middle section, which has a uniform cross-sectional shape, and passing the mixed gas through the diffusion section, which gradually widens in a cross-sectional view.

In some embodiments, the fuel exhaust stream is a hydrogen exhaust stream, and a hydrogen concentration in the mixed gas is 1% or less upon exiting the outlet of the second chamber.

In some embodiments, the outlet of the second chamber has an opening wider than an inlet of the second chamber, a longitudinal axis of the tunnel within the first chamber is aligned with a longitudinal axis of the second chamber, and a length of the second chamber is at least three times a length of the first chamber.

In some embodiments, the first inlet is located on a side of the first chamber and aligned with a longitudinal axis of the first chamber, and the second inlet is located on an upper portion of the first chamber and oriented perpendicular to the longitudinal axis of the first chamber.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A fuel exhaust dilution structure, comprising:
a first chamber, comprising:
a first inlet through which a fuel exhaust stream generated by a fuel cell stack enters the fuel exhaust dilution structure;
a second inlet for receiving ambient air; and
a tunnel within the first chamber and connected to the first inlet, the tunnel receiving the fuel exhaust stream from the first inlet, and the tunnel being positioned and shaped to draw the ambient air into the first chamber through the second inlet; and
a second chamber connected to the first chamber, the second chamber configured to receive and mix the fuel exhaust stream and the ambient air to generate a mixed gas, and the second chamber comprising an outlet through which the mixed gas exits the fuel exhaust dilution structure.

2. The fuel exhaust dilution structure of claim 1, wherein the tunnel within the first chamber comprises a throat region configured to accelerate the fuel exhaust stream, the throat region being a narrowest part of the tunnel in a cross-sectional view.

3. The fuel exhaust dilution structure of claim 2, wherein the tunnel within the first chamber further comprises a converging section and an expanding section, and wherein:
the converging section is positioned after the first inlet and has an internal space gradually narrows in a cross-sectional view;
the throat region is positioned between the converging section and the expanding section; and
the expanding section has an internal space that gradually widens in a cross-sectional view.

4. The fuel exhaust dilution structure of claim 3, wherein the second chamber comprises a decreasing section, a middle section, and a diffusion section, and wherein:
the decreasing section is connected to the first chamber and gradually narrows in a cross-sectional view;
the middle section is connected to the decreasing section and maintains a uniform cross-sectional shape; and
the diffusion section is connected to the middle section and gradually widens in a cross-sectional view.

5. The fuel exhaust dilution structure of claim 4, wherein:
the outlet of the second chamber has an opening wider than an inlet of the second chamber.

6. The fuel exhaust dilution structure of claim 1, wherein the fuel exhaust stream is a hydrogen exhaust stream.

7. The fuel exhaust dilution structure of claim 6, wherein a hydrogen concentration in the mixed gas is 1% or less upon exiting the fuel exhaust dilution structure through the outlet of the second chamber.

8. The fuel exhaust dilution structure of claim 1, wherein the first inlet is located on a side of the first chamber and aligned with a longitudinal axis of the first chamber, while the second inlet is located on an upper portion of the first chamber and oriented perpendicular to the longitudinal axis of the first chamber.

9. The fuel exhaust dilution structure of claim 1, wherein a longitudinal axis of the tunnel within the first chamber is aligned with a longitudinal axis of the second chamber.

10. The fuel exhaust dilution structure of claim 1, wherein a length of the second chamber is at least three times a length of the first chamber.

11. A method, comprising:
receiving a fuel exhaust stream generated by a fuel cell stack through a first inlet of a first chamber within a fuel exhaust dilution structure;
directing the fuel exhaust stream through a tunnel within the first chamber, wherein the tunnel is positioned and shaped to draw ambient air into the first chamber through a second inlet of the first chamber;
directing the fuel exhaust stream and the ambient air into a second chamber within a fuel exhaust dilution structure, wherein the second chamber is connected to the first chamber and is configured to mix the fuel exhaust stream and the ambient air to generate a mixed gas; and
expelling the mixed gas through an outlet of the second chamber, wherein the mixed gas has a reduced fuel concentration compared to the fuel exhaust stream received at the first inlet.

12. The method of claim 11, wherein:
the tunnel within the first chamber comprises a throat region configured to create a Venturi effect, with the throat region being a narrowest part of the tunnel in a cross-sectional view, generating a low-pressure zone downstream of the tunnel to draw the ambient air through the second inlet of the first chamber.

13. The method of claim 12, further comprising:
passing the fuel exhaust stream through a converging section of the tunnel, wherein the converging section gradually narrows in a cross-sectional view;
directing the fuel exhaust stream through the throat region, which is located between the converging section and an expanding section of the tunnel; and
passing the fuel exhaust stream through the expanding section, wherein the expanding section gradually widens in a cross-sectional view.

14. The method of claim 13, wherein the second chamber comprises a decreasing section, a middle section, and a diffusion section, the method further comprising:
passing the fuel exhaust stream and the ambient air through the decreasing section, which gradually narrows in a cross-sectional view;
mixing the fuel exhaust stream and the ambient air and generating a turbulent flow in the decreasing section;
passing the mixed gas through the middle section, which has a uniform cross-sectional shape; and
passing the mixed gas through the diffusion section, which gradually widens in a cross-sectional view.

15. The method of claim 11, wherein the fuel exhaust stream is a hydrogen exhaust stream, and a hydrogen concentration in the mixed gas is 1% or less upon exiting the outlet of the second chamber.

16. The method of claim 11, wherein:
the outlet of the second chamber has an opening wider than an inlet of the second chamber;
a longitudinal axis of the tunnel within the first chamber is aligned with a longitudinal axis of the second chamber; and
a length of the second chamber is at least three times a length of the first chamber.

17. The method of claim 11, wherein:
the first inlet is located on a side of the first chamber and aligned with a longitudinal axis of the first chamber, and
the second inlet is located on an upper portion of the first chamber and oriented perpendicular to the longitudinal axis of the first chamber.

18. A system, comprising:
a fuel storage tank;
a fuel cell stack configured to receive fuel from the fuel storage tank and generate electrical power;
a pressure regulator configured to control a fuel pressure within the fuel storage tank;
a radiator fan and a coolant pump configured to regulate and dissipate heat generated during operation of the fuel cell stack;
one or more sensors configured to measure operational parameters;
a DC/DC converter configured to convert a voltage output by the fuel cell stack to desired voltage;
a system controller configured to monitor and control operation of the system; and
a fuel exhaust dilution structure, comprising:
a first chamber, comprising:
a first inlet through which a fuel exhaust stream generated by a fuel cell stack enters the fuel exhaust dilution structure;
a second inlet for receiving ambient air; and
a tunnel within the first chamber and connected to the first inlet, the tunnel receiving the fuel exhaust stream from the first inlet, and the tunnel being positioned and shaped to draw the ambient air into the first chamber through the second inlet; and
a second chamber connected to the first chamber, the second chamber configured to receive and mix the fuel exhaust stream and the ambient air to generate a mixed gas, and the second chamber comprising an outlet through which the mixed gas exits the fuel exhaust dilution structure.

19. The system of claim 18, wherein:
the tunnel is configured to create a Venturi effect, generating a low-pressure zone downstream of the tunnel to draw the ambient air through the second inlet of the first chamber;
the fuel exhaust stream is a hydrogen exhaust stream; and
a hydrogen concentration in the mixed gas is 1% or less upon exiting the outlet of the second chamber.

20. The system of claim 19, wherein:
the outlet of the second chamber has an opening wider than an inlet of the second chamber;
the second chamber comprise a narrowest section located at a middle portion of the second chamber;
a longitudinal axis of the tunnel within the first chamber is aligned with a longitudinal axis of the second chamber; and
a length of the second chamber is at least three times a length of the first chamber.
